(19) United States
(12) Patent Application Publication
(10) Pub. No.: US 2021/0121971 A1
(43) Pub. Date: Apr. 29, 2021

(54) METHOD AND DEVICE FOR PLASMA CUTTING OF WORK PIECES

(71) Applicant: Linde Aktiengesellschaft, München (DE)

(72) Inventor: Nakhleh A. HUSSARY, Ismaning (DE)

(21) Appl. No.: 16/635,639

(22) PCT Filed: Jul. 9, 2018
(86) PCT No.: PCT/EP2018/025186

§ 371 Date: Jan. 31, 2020

(30) Foreign Application Priority Data
Jul. 31, 2017 (GB) 1712301.9

(51) Int. Cl. B23K 10/00; H05H 1/34

(52) U.S. Cl. CPC B23K 10/00; H05H 2001/3457; H05H 1/341

(57) ABSTRACT

The present invention relates to a method and device for CO₂ plasma cutting of a work piece, using a plasma cutting torch, wherein an arc is generated between the cutting head and the work piece, and a shielding gas is provided around the arc, characterized in that the shielding gas comprises CO₂-snow or a mixture containing CO₂-snow.

### TECHNICAL FIELD

The invention relates to a method and a device for plasma cutting of work pieces.

### BACKGROUND

A plasma is a super-heated, electrically conductive fluid composed of positive and negative ions, electrons and excited and neutral atoms and molecules. Different gases/fluids can be used as the plasma gases/fluids. These gases/fluids dissociate and ionize by means of the electrical energy deposited into the plasma by the electric arc.

The plasma arc cutting process, also known as plasma cutting or arc cutting, a well-known manufacturing process, is commonly used for cutting, marking and gouging of conductive materials. Plasma cutting uses a highly constricted arc with a high energy density and high pressure to heat, melt and blow the resulting molten material off a workpiece to be cut. The process typically uses a plasma forming gas and a shielding fluid. The shielding fluid can be a gas or a liquid that is injected around a main plasma arc. In earlier developments, gas was commonly used as a shield, and subsequently liquid water was also used within the first few years of the invention of the process.

In plasma cutting, a cutting torch is utilized, which typically comprises an electrode, a nozzle, a plasma gas distributor, a shield gas/fluid distributor and a shield cap. In the following, such a shield cap is sometimes simply referred to as a shield. Herein, the nozzle coaxially surrounds the electrode, defining a passage for passing of a plasma forming gas therebetween, and the shield cap coaxially surrounds the nozzle, defining a passage for passing of a shielding gas or fluid therebetween. The nozzle is provided with passages for a plasma gas and the shield cap is provided with passages for a shielding fluid. Within the nozzle, a plasma arc is generated between the nozzle and the electrode during the piloting phase. As the arc exits the nozzle, under the action of the plasma forming gas flow, the power supply senses the extension of the arc towards the work piece and disconnects the nozzle from the circuit forcing the arc to fully transfer to the work piece. The parameters of a plasma arc can be influenced by the design of the nozzle, from which the plasma arc is ejected, and the electrode within the nozzle, shield nozzle, and both the gas/fluid distribution members for both the plasma and the shield lines.

It is the goal of plasma cutting system to provide a plasma cutting arc that achieves the highest cutting speed at the highest cutting quality and therefore at the best cost base. Quality is, in part, defined as the lack of bottom dross (solidified metal hanging on the lower edge of the cut face), angularity of the cut surface as well as its smoothness. To achieve such goals, the plasma cutting arc needs to provide high energy density at a very localized footprint during cutting. The stability of the arc must be maintained to avoid any striations and imperfections of the surface of the cut and provides controlled repeatability. Therefore, the plasma cutting arcs tend to be highly constricted. Traditionally, the constriction is achieved through a number of methods known in the prior art literature. Four main methods are typically used, (1) wall constriction and stabilization, (2) plasma gas swirl flow constriction and stabilization, (3) shield flow constriction and stabilization and (4) magnetic constriction and stabilization. There are limitations to all the above methods. For example, a small diameter nozzle that provides wall constriction and stabilization is limited by the high arc heat load (the smaller the diameter at a given current/power level the higher the heat load will be) and the nozzle material selection (typically copper or high thermal conductivity metals) that allows the removal of such heat. Similarly, a properly established plasma forming gas swirl enhances such constriction and stabilization when combined in a correct way with the selected plasma gas nozzle orifice design. Furthermore, properly injecting the correct amount of shield flow (gas or liquid, swirled or non-swirled) dramatically improves the constriction and stability of the arc. Magnetic constriction, while theoretically possible, tends to require a large magnetic field values, on the order of a Tesla rendering it industrially impractical for constriction purposes. The injection shield flow improves the arc constriction by properly shaping the boundary layer between the arc and the outside atmosphere. As the shield flow is injected around the arc, it cools the fringes of the arc effectively decreasing its foot print. The cooled arc fingers no longer possess the high temperature required to carry the electrical current. The effective decrease of the current carrying cross section, therefore, forces an increase in temperature of the plasma core, thereby increasing the electrical conductivity of the plasma to compensate for such cross section reduction and maintain the constant current provided by the power source. The shield flow also provides a buffer against the atmosphere and preserves the chemistry of the plasma flow, minimizes or enhances the flow velocity of the arc and the overall flow field.

It is the intent of this invention to improve on the use of shield flow gas and the shield flow liquid (typically water) by injecting CO₂ snow. There is provided enhanced arc cooling and shaping of the arc. The CO₂ snow sublimes and it leaves no liquid that flows over the surface of the metal to be cut. It also provides a means of preventing the atmospheric gases from contaminating the plasma arc and changing its desired chemistry.

Plasma cutting is an intense source of pollutants, these pollutants including metal particulates and gases (e.g. ozone, NO, NO₂, . . . ), electromagnetic radiation (UV light) and sound emissions. In the prior art, a number of technologies have been introduced to reduce these sources of pollutants, such as a water muffler providing a curtain around the torch to capture fumes, UV light and to reduce sound levels. Further prior art methods include underwater cutting, where the torch and/or the work piece are fully or partially submerged in water during the cutting process. Furthermore, water tables, in which the water level is at or just below the bottom surface of a plate being cut, and down draft tables, in which the ambient air is sucked through the table and passed through filters, have been used. Furthermore, it is known to introduce water as the shielding fluid in the plasma cutting torch.

These technologies have drawbacks. For example, under water cutting or water tables produce waste water that has to be properly collected, stored and disposed of, which leads to higher operating costs. Underwater cutting and water table cutting produce lower quality cuts and reduce the consumable life of the plasma cutting torches, especially of torch components such as electrodes, nozzles and shield caps. In some applications, so called water mufflers are used. These are components that are used to introduce water around the plasma torches. Typically, these are provided as additional components that are not designed as part of the torch. Water mufflers also inject water that gets contaminated and requires collection and disposition. Also, water leaves marks on the work piece or plate, that are especially undesirable for aluminium and stainless steel, so that this leads to the requirement of further cleaning, and can also cause rusting on mild steel.

Down draft tables tend to be the most useful for dust collection, but in facilities where the plate being cut is very large, the design of the table becomes critical to be able to extract all of the fumes. Furthermore, water impacting the filters of down draft tables can cause damage to the filters, thereby reducing their effectiveness and life. Down draft tables are not able to reduce noise or block UV arc radiation.

A further solution that has been used in plasma cutting is the use of water as shielding fluid, which is injected around the main plasma arc as it exits the nozzle of the cutting torch. Water is introduced around the arc tangentially, radially or in at angular vector to further constrict the arc. The amount of water used varies with the particular design. Typically, substantially less water is used herein compared to water used as a curtain around the main torch in connection with water mufflers. Nevertheless, introducing water on top of stainless steel and aluminium plates are still not desirable. Also, cutting water caught in the filters of down draft cutting tables will reduce their usable life.

It is the object of the invention to provide a plasma cutting method and device, with which the disadvantages outlined above can be minimized or prevented.

### DISCLOSURE OF THE INVENTION

This object is achieved by a method and a device comprising the features of the respective independent claims.

According to the invention, in a method for plasma cutting of a work piece using a plasma cutting torch, wherein a plasma arc is generated between the cutting torch and the work piece, and a shielding flow is provided around the plasma arc, the shielding flow comprises CO₂-snow or a mixture containing CO₂-snow. It is noted that the term “shielding flow” as used herein is meant to comprise any flow of material comprising solid and/or fluid, i.e. liquid and/or gaseous, components. The term “mixture containing CO₂-snow” as used herein is to be understood as comprising mixture of CO₂-snow with any expediently chosen gases and/or fluids and/or solids.

By injecting CO₂ snow onto the work piece, i.e. by ejecting it from the cutting torch, there is provided enhanced arc cooling and shaping of the arc. The CO₂ snow sublimes and it leaves no liquid that flows over the surface of the metal to be cut. It also provides a means of preventing the atmospheric gases from contaminating the plasma arc and changing its desired chemistry.

The CO₂-snow thus ejected from the cutting torch around the plasma arc acts as a curtain to immediately cool, condense and nucleate any metallic fume generated on the work piece into particulates, preventing an uncollected escape. Furthermore, it effectively reduces noise levels generated by the process by acting as a damping barrier to the noise generated by the plasma arc. Also, it absorbs UV radiation generated in the process and prevents the formation of ozone further away from the arc zone along the radiation path. CO₂-snow acting as a shielding flow also cools the outside of the torch during cutting or piercing of thick material work pieces and during higher current operation, whereby the life of a plasma cutting torch and its consumables, especially nozzle, electrode shield cup etc. can be increased. Also, it effectively cools thinner work pieces such as thin plates, thereby reducing warpage and thus eliminating complex procedures of nesting various cutting paths across the length and width of the work piece, which, in prior art applications, can increase cutting time and reduce the process throughput. According to a preferred embodiment, the shielding flow is provided together with or without a carrier gas or fluid. Using carrier gases or fluids provides an effective way of injecting a shielding flow in a desired amount and direction. On the other hand, providing a shielding flow without a carrier gas can be advantageous for certain applications.

According to a preferred embodiment, the shielding flow is provided in a flow path which is split into a first central flow component provided directly around the arc and at least one second coaxial flow component provided coaxially around the central flow component. Each flow component can provide an effective curtain around the plasma arc. The central flow component is especially provided to constrict the plasma arc and enhance the cutting process.

Advantageously, the first flow component of the shielding flow and the second flow component of the shielding flow are directed essentially in a direction parallel to a main extension direction of the plasma arc between the cutting torch and the work piece.

It is also possible to provide the first and/or the second flow components of the shielding flow directed in a direction forming a closing or an opening angle relative to the main extension direction of the plasma arc. For certain designs, an opening angle helps in protecting the torch during the piercing which causes metal blowback during the piercing process. Similarly, a closing angle can also help in this respect. The outer component of the flow, aside from protecting the torching during the piercing phase and the cutting phase of the process, also acts as a built-in “CO₂ muffler” to reduce overall emissions, i.e. electromagnetic radiation including UV (causing ozone generation) NOx, particulate, noise, etc.

It is also possible to provide a shielding flow or at least one of the first and second flow components of a shielding flow directed towards the arc in a direction perpendicular or essentially perpendicular to the main extension direction of the arc.

It is also advantageous to provide the shielding flow with a rotational component defining a rotational movement about the main extension direction of the plasma arc. This further improves the constriction of the plasma's arc and therefore, improves the cuttings speed and quality.

According to a preferred embodiment of the device according to the invention adapted to implement the method according to the invention, it comprises a cutting torch provided with an electrode, which is coaxially surrounded by a nozzle, thereby defining a passage for passing of a plasma gas between electrode and nozzle, the nozzle being coaxially surrounded by a shielding cap, thereby defining a passage for passing of a shielding flow between nozzle and shielding cap, wherein the passage for a shielding flow is configured and adapted for use of CO₂-snow or mixture containing CO₂-snow as shielding flow.

Advantageously, the plasma cutting torch is provided with means to provide the at least one passage to supply a shield flow comprising CO₂-snow such that the CO₂ is injected around the main plasma arc.

Further, the device advantageously comprises a plasma cutting torch provided with means to provide at least two passages to supply a shield flow comprising CO₂-snow and further another pathway to provide a carrier gas, the carrier gas especially being selected from a group comprising CO₂ gas, N₂ gas, air, oxygen, argon, argon-hydrogen mix, argon-hydrogen-nitrogen mix, or a combination of the above gases.

According to a further preferred embodiment, the device comprises a shield member such that the CO₂-snow shield flow is injected around a main arc in a coaxial manner or in a radial manner or in a radial and swirling manner, especially either in a clockwise or counterclockwise direction.

Advantageously, the device comprises a shield member such that the CO₂-snow shield flow injected around the main arc is in an angular manner and/or swirling manner, especially either in a clockwise or counterclockwise direction.

Advantageously, the device comprises a shield member comprising multiple components to generate a swirling CO₂-snow shield flow.

Expediently, the shield member is adapted to split the CO₂ shield flow, one flow component directed around a main arc and a second flow component being provided around the shield member further away from the arc.

According to preferred embodiments, the second flow component exits the shield member in a direction parallel to a main arc or in a direction pointing away from the main arc or in a direction pointing towards the main arc. Preferred embodiments of the invention will now be described with reference to the figures.

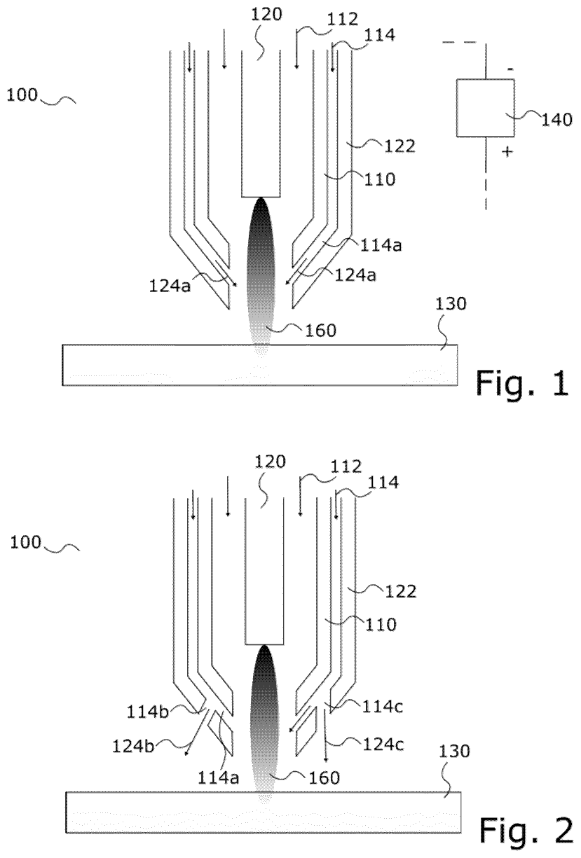

FIG. 1 shows a schematic side sectional view of a plasma cutting torch adapted to implement a first preferred embodiment of the method according to the invention,

FIG. 2 a further schematic side sectional view of a plasma cutting torch adapted to implement a second preferred embodiment of the method according to the invention,

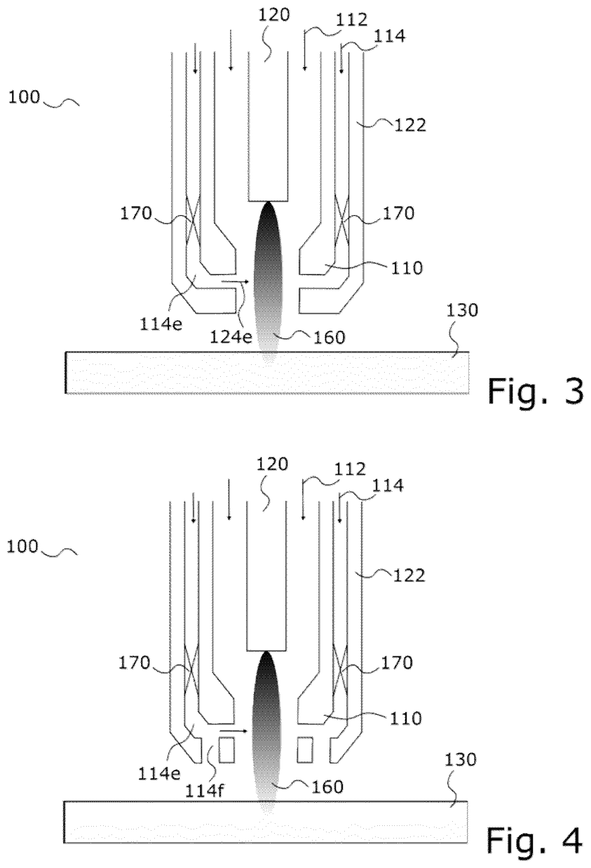

FIG. 3 shows a further schematic side sectional view of a plasma cutting torch adapted to implement a third preferred embodiment of the method according to the invention, and

FIG. 3 shows a further schematic side sectional view of a plasma cutting torch adapted to implement a fourth preferred embodiment of the method according to the invention.

In FIG. 1, a schematic side sectional view of a cutting torch for plasma cutting is shown. The torch is generally designated 100. The cutting torch 100 comprises an electrode (cathode 120) coaxially surrounded by a nozzle 110. Electrode 120 and nozzle 110 defines a central passage 112 for passing of a plasma gas around electrode 120, i.e. between electrode 120 and nozzle 110. Coaxially surrounding nozzle 110 there is provided a shield 122, defining a passage 114a for a shielding flow between nozzle 110 and shield 122. The cutting torch 100 is arranged above a work piece 130 to be cut, the work piece acts as an anode during plasma cutting.

As is well-known in the art, an electrical cutting current flows from a schematically shown current source 140 to the plasma cutting torch 110 via electrode 120, a plasma arc 160 constricted by the nozzle 110 to the work piece 130 and back to the current source 140 (only shown in FIG. 1). As is also well-known in the art, this arrangement leads to formation of a plasma cutting arc 160 between the electrode 120 and the work piece 130. The cutting arc 160 defines a main extension direction along the shortest line between the electrode 120 and the work piece 130.

In order to achieve a highly constricted plasma arc 160 for plasma cutting, it is proposed to use CO₂-snow as a shielding flow passing through passage 114. This CO₂-snow acts as a constricting flow (gas-solid mixture, i.e. a two phase flow) for cooling the fringes of arc 160. As the fringes of the plasma arc cool down, the arc diameter decreases, causing an increase in the core temperature of the plasma. This results in an increase in electrical conductivity of the plasma arc 160, thereby allowing conduction of the same current through a reduced cross sectional area of the plasma arc. This increase in arc constriction improves the piercing capacity, cutting speed and cutting quality achievable with plasma arc 160. This improves the constriction in traditional shield gas flows. It also eliminates the drawbacks of liquid water injection due to the sublimation of the CO₂ snow.

The CO₂-snow may be injected without any further carrier gas through passage 114. In a preferred embodiment, however, CO₂-snow is injected together with a carrier gas, such as nitrogen, oxygen, air, argon, etc. or a mixture thereof.

As can be seen from FIG. 1, the lower section 114a of passage 114 is arranged so that it is directed towards the plasma arc 160, i.e. defining a closing angle relative to plasma arc 160. This arrangement leads to an especially efficient constriction of the plasma arc. The direction of shielding flow ejected out of section 114a is indicated by arrow 124a.

The CO₂-snow thus ejected around the plasma arc 160 acts also as a curtain to immediately cool, condense and nucleate any metallic fume generated on the work piece 130 into particulates, preventing an uncollected escape. Furthermore, it effectively reduces noise levels generated by the process by acting as a damping barrier to the noise generated by the plasma arc. Also, it absorbs UV radiation generated in the process and prevents the formation of ozone further away from the arc zone along the radiation path. CO₂-snow acting as a shielding flow also cools the outside of the torch during cutting or piercing of thick material work pieces and during higher current operation, whereby the life of a plasma cutting torch and its consumables, especially nozzle, and shield etc. can be increased. Also, it effectively cools thinner work pieces such as thin plates, thereby reducing warpage and thus eliminating complex procedures of nesting various cutting paths across the length and width of the work piece, which, in prior art applications, can increase cutting time and reduce the process throughput.

Also, as CO₂-snow sublimes, it leaves no residue on the work piece being cut, and it can cleanly and easily pass through filters for example of a down draft table.

FIG. 2 shows further preferred embodiments of a cutting torch adapted to implement two variations of an embodiment of the method of the invention. Similar components as already discussed referring to FIG. 1 are designated with the same reference numerals, and will not be described in detail again.

The main difference over the previously discussed embodiment is that the flow path through passage 114 for CO₂-snow is split into a central section 114a, corresponding to the lower section 114a as described with reference to FIG. 1, and a further outwardly directed section 114b or, alternatively, 114c adapted to further protect the cutting zone and provide a second curtain surrounding the curtain provided by the first passage 114a through which shielding fluid is ejected.

In FIG. 2, two possible orientations of such a coaxial section are shown. In actual embodiments, only one of these two variants will be implemented within one nozzle. On the left hand side, a coaxial section 114b defining an opening angle relative to the main extension direction of plasma arc 160 is shown, i.e. an angle directed away from the main extension direction of plasma are 160 (as indicated by arrow 124b). On the right hand side of FIG. 2, a coaxial path 114c extending essentially parallel to the main extension direction of plasma arc 160 is shown, leading to an ejection of shielding flow parallel to the main extension direction of plasma arc 160, as indicated by arrow 124c. Be it noted that the coaxial path could also be directed in a closing angle, i.e. towards the main extension of plasma arc 160, although this variant is not shown in FIG. 2.

According to a further embodiment shown in FIG. 3, CO₂-snow may also be directed in a radial direction directly at the plasma arc 160, i.e. in a direction essentially perpendicular to the main extension direction of the plasma arc (arrow 124e). To implement this variant, the lower section 114e of passage 114 is oriented in a direction perpendicular to the upper sections of passages 114 and to the main direction of plasma arc 160. Here again, passage 114 could be split, for example into one section as defined by lower sections 114e, and a further section in which CO₂-snow is ejected in a coaxial manner with limited or no direct impact on the plasma arc 160, i.e. essentially parallel to the main direction of plasma arc 160.

Be it noted that the introduction of CO₂-snow can be provided in such a way that CO₂-snow and a carrier gas are introduced into the various passages 114. Alternatively, feed stock such as liquid CO₂ or CO₂-gas can be fed directly into passage 114, and the CO₂-snow generation process effected within passage 114, as schematically indicated at reference numeral 170 in FIG. 3, which shows a snow generation zone.

A further carrier gas line may be provided to introduce a carrier gas for the CO₂-snow into the cutting torch. This further gas line (not shown in FIG. 3) can be provided at the upper end of the torch, to integrally mix carrier gas with CO₂-snow after its generation. Such a carrier gas line could also be provided externally and introduced into the torch after CO₂-snow is generated.

FIG. 4 shows a further possible implementation of a nozzle 110 of a cutting torch for implementing a further embodiment of the method according to the invention. Here, the CO₂-flow, as provided through passage 114, is split into multiple parts after CO₂-snow generation at 170. As can be seen, passage 114 is provided with a first lower section 114e, corresponding to the lower section 114e of FIG. 3, which leads to a direction of CO₂-snow radially or perpendicularly upon plasma arc 160. A further section 114f is provided, which leads to an injection of CO₂-snow essentially parallel to the main extension direction of arc 160.

In a further implementation, not shown in the figures, a rotational or swirl flow could be imposed on the CO₂-snow, providing it with a rotational component relative to the main direction of plasma are 160. This may be achieved by different methods such as having injection ports that are offset from the center of the cutting torch such that the flow is injected off center, thereby generating a swirling component.

All advantages discussed in connection with the embodiment of FIG. 1 are equally applicable to the variants shown in FIGS. 2 to 4.

Be it noted that a constant amount of CO₂-snow can be used at all current levels and material thicknesses to be cut. However, in preferred implementations, the amount of CO₂ used is an increasing function of the current of the plasma cutting arc. Specifically, it is advantageous to set the CO₂-snow flow rate as a function of the current level of the plasma arc. Also, the CO₂-snow flow rate can be set to match the plasma gas flow at a rate of 1:1, 0.5:1, 2:1, 5:1 and 15:1. Intermediate, lower or higher ratios are also possible. Also much higher flow rates are possible with the implementations shown in FIG. 2 through FIG. 4.

The method as described, using CO₂-snow as a shielding fluid, may be used for cutting various materials, especially, but not limited to, mild steel or carbon steel, stainless steel, aluminum, copper, titanium, brass etc.

In a preferred embodiment, the following combinations of CO₂-snow and carrier gas may be considered advantageous, for example for carbon steel cutting: oxygen plasma in combination with CO₂-snow as shielding fluid and an oxygen gas as carrier gas, or oxygen plasma in combination with CO₂-snow as shielding fluid and air as carrier gas.

For stainless steel or aluminum, and also for certain non-ferrous materials: nitrogen plasma can be used in combination with CO₂-snow as shielding fluid and nitrogen gas as carrier gas, or Ar—H₂ mixture (example: 35% H₂ with the balance argon, often referred to as H35) plasma in combination with CO₂-snow as shielding fluid and nitrogen gas as carrier gas, or Ar—H₂ mixture (example H35) plasma in combination with CO₂-snow and Ar—H₂ gas mixture as carrier gas, or Ar—H₂ and N₂ plasma (with various mix ratios) in combination with CO₂-snow as shielding fluid and nitrogen gas as carrier gas, or Ar—H₂ and N₂ plasma (with various mix ratios) in combination with CO₂-snow and Ar-H₂+N₂ gas mixture as carrier gas, or an N₂—H₂ mixture (example: F5) as plasma in combination with CO₂-snow as shielding fluid and nitrogen gas as carrier gas.

The ratios between CO₂-snow and the carrier gas flow are advantageously related in such a way that the carrier gas flow rate is set at 0.5 of the CO₂-snow flow rate, or is set to match the CO₂-snow flow rate, or is set at twice the CO₂-snow, or is set at 5 times the CO₂-snow, or is set at ten or 15 times the CO₂-snow flow rate. Intermediate or higher ratios are also possible.

1. Method for plasma cutting of a work piece, using a plasma cutting torch, wherein a plasma arc is generated between the cutting torch and the work piece, and a shielding flow is provided around the arc, characterized in that the shielding flow comprises CO₂-snow or a mixture containing CO₂-snow.

2. Method according to claim 1, wherein the shielding flow is provided together with or without a carrier gas.

3. Method according to claim 1, wherein the shielding flow is provided in a flow path which is split into a first central flow component provided directly around the plasma arc and at least a second coaxial flow component provided coaxially around the central component.

4. Method according to claim 3, wherein the first flow component of the shielding flow and the second flow component of the shielding flow are directed essentially in a direction parallel to a main extension direction of the plasma arc between the cutting torch and the work piece.

5. Method according to claim 3, wherein the first and/or the second flow components of the shielding flow are directed in a direction forming a converging or a diverging angle relative to the main extension direction of the plasma arc between the cutting torch and the work piece.

6. Method according to claim 1, wherein the shielding flow or at least one of the first and second flow components of the shielding flow is directed towards the plasma arc in a direction perpendicular or essentially perpendicular to the main extension direction of the plasma arc between the cutting torch and the work piece.

7. Method according to claim 1, wherein the shielding flow is provided with a rotational component defining a rotational movement about the main extension direction of the plasma arc between the cutting torch and the work piece.

8. Device for plasma cutting, comprising a cutting torch (100), provided with an electrode (120), which is coaxially surrounded by a nozzle (110), thereby defining a passage (112) for passing of a plasma gas between electrode and nozzle, wherein the nozzle is coaxially surrounded by a shielding cap (122), thereby defining at least one passage (114) for passing of a shielding flow between nozzle and shielding cap, wherein passage (114) for a shielding flow is configured and adapted for use of CO₂-snow or a mixture containing CO₂-snow as shielding flow.

9. Device according to claim 8, wherein the plasma cutting torch is provided with means to provide the at least one passage (114) to supply a shield flow comprising CO₂ snow such that the CO₂-snow is injected around a main plasma arc.

10. Device according to claim 8, comprising a plasma cutting torch provided with means to provide at least two passages to supply a shield flow comprising CO₂-snow and further another pathway to provide a carrier gas, the carrier gas especially being selected from a group comprising CO₂ gas, N₂ gas, air, oxygen, argon, argon-hydrogen mix, argon-hydrogen-nitrogen mix, or a combination of the above gases

11. Device according to claim 8, comprising a shield member such that the CO₂-snow shield flow is injected around a main arc in a coaxial manner or
in a radial manner or
in a radial and swirling manner, especially
either in a clockwise or a counterclockwise direction.

12. Device according to claim 8, comprising a shield member such that the CO₂-snow shield flow injected around the main arc is in an angular manner and/or
swirling manner, especially
either in a clockwise or a counterclockwise direction.

13. Device according to claim 8, comprising a shield member comprising multiple components to generate a swirling CO₂ snow shield flow.

14. Device according to claim 8, comprising a shield member that splits the CO₂ shield flow, one flow component directed around a main arc and a second flow component being provided around the shield member further away from the arc.

15. Device according to claim 14, wherein the second flow component exits the shield member in a direction parallel to a main arc, or
in a direction pointing away from the main arc or
in a direction pointing towards the main arc.
